(19) United States
(12) Patent Application Publication
(10) Pub. No.: US 2026/0331533 A1
(43) Pub. Date: Oct. 22, 2026

(54) Flow Field Plate and Manufacturing Method Therefor, and Bipolar Plate and Manufacturing Method Therefor

(71) Applicant: Robert Bosch GmbH, Stuttgart (DE)

(72) Inventor: Xiaogang Hao, Shanghai (CN)

(21) Appl. No.: 19/103,474

(22) PCT Filed: Aug. 18, 2022
(86) PCT No.: PCT/CN2022/113295

§ 371 Date: Feb. 12, 2025

(51) Int. Cl. H01M 8/0258; H01M 8/0284; H01M 8/10; H01M 8/1004

(52) U.S. Cl. CPC H01M 8/0258; H01M 8/0284; H01M 8/1004; H01M 2008/1095

(57) ABSTRACT

A method for manufacturing a flow field plate for a fuel cell unit is disclosed. The method includes forming a first flow field for circulating reactive fluid on a first side of a metal plate, with the reaction zone of the first flow field including a first ridge defining a first flow channel. Forming the first flow field includes (i) cutting a first pattern corresponding to the first ridge in a first conductive adhesive film, and (ii) and adhering the cut first pattern onto the first side of the metal plate, such that at least 10% of the height of the first ridge, measured from the top, is formed by the first pattern. Also disclosed is a method for manufacturing a bipolar plate for a fuel cell, as well as the flow field plate and bipolar plate manufactured by the aforementioned method. With the above, the contact conductivity of the flow field plate can be improved, making the flow field plate easy to manufacture and reducing the manufacturing cost of the flow field plate.

### TECHNICAL FIELD

The present application generally relates to fuel cell technology, and more particularly, to flow field plates, bipolar plates for use in fuel cells and their manufacturing methods.

### BACKGROUND ART

Fuel cells, which generate electricity through electrochemical reactions between a fuel and an oxidant, are increasingly being used to provide power, especially in the field of electric vehicles. Proton-Exchange Membrane Fuel Cells (PEMFCs) are a widely used type of fuel cell that utilizes hydrogen as the fuel and oxygen as the oxidant. Typically, a Membrane Electrode Assembly (MEA) is disposed between two flow field plates to form a fuel cell unit. The two flow field plates serve as the cathode plate and anode plate, respectively, and comprise flow fields for supplying reactive fluids (i.e., hydrogen, oxygen, or air) to the MEA.

Metals are commonly used to manufacture flow field plates due to their excellent thermal conductivity, electrical conductivity, and density. However, in the operating environment of PEMFCs (e.g., low pH, high humidity, and an operating temperature of approximately 80 °C), typical metal materials used for flow field plates (such as stainless steel and titanium) exhibit chemical instability, leading to issues with corrosion resistance and contact conductivity of the metal flow field plates.

In existing flow field plate manufacturing techniques, carbon-based coatings are typically applied to metal flow field plates to improve their corrosion resistance and contact conductivity. However, applying carbon-based coatings requires a vacuum environment, making the process complex, time-consuming, and costly, which is not conducive to the large-scale production of flow field plates. Additionally, to maintain a substantially constant contact resistance between the carbon-coated flow field plate and the MEA, a significant holding force must be maintained between the flow field plate and the MEA. This relies on the pile fixture of the fuel cell. However, due to vibrations in the operating environment of the fuel cell, the fixture may loosen, leading to a reduction in holding force and consequently an increase in contact resistance between the flow field plate and the MEA.

Therefore, there is a need to improve the existing flow field plate manufacturing technology.

### SUMMARY OF THE INVENTION

The present application aims to provide an improved method for manufacturing a flow field plate for a fuel cell unit, to overcome at least one of the aforementioned defects.

According to one aspect of the present application, a method for manufacturing a flow field plate for a fuel cell unit is provided. The method comprises: forming a first flow field for circulating reactive fluid on a first side of a metal plate, with the reaction zone of the first flow field comprising a first ridge defining a first flow channel. Forming the first flow field comprises the following steps: cutting a first pattern corresponding to the first ridge in a first conductive adhesive film; and adhering the cut first pattern onto the first side of the metal plate, such that at least 10% of the height of the first ridge, measured from the top, is formed by the first pattern.

According to another aspect of the present application, a method for manufacturing a flow field plate for a fuel cell unit is provided, comprising: manufacturing a cathode plate using the aforementioned method; manufacturing an anode plate using the aforementioned method; and fixing the cathode plate and the anode plate together with the first flow fields facing each other to form a bipolar plate.

According to yet another aspect of the present application, a flow field plate for a fuel cell unit is provided, comprising: a metal plate; a first flow field formed on the first side of the metal plate for circulating reactive fluid, with the reaction zone of the first flow field comprising a first ridge defining a first flow channel; and a first conductive adhesive film, wherein, the first conductive adhesive film is in a first pattern corresponding to the first ridge and is adhered to the first side of the metal plate such that at least 10% of the height of the first ridge, measured from the top, is formed by the first pattern.

According to a further aspect of the present application, a bipolar plate for a fuel cell is provided, comprising: an anode plate, which is one of the aforementioned flow field plates; a cathode plate, which is another of the aforementioned flow field plates; wherein, the anode plate and the cathode plate are fixed together with the first flow fields facing away from each other.

According to the present application, the contact conductivity of the flow field plate can be improved, making the flow field plate easy to manufacture and reducing the manufacturing cost of the flow field plate.

### DESCRIPTION OF ACCOMPANYING DRAWINGS

The above and other aspects of the present disclosure will be understood and appreciated more thoroughly below in connection with the appended drawings. It should be noted that the drawings are merely illustrative and not drawn by scale. In the accompanying drawings,

FIG. 1 schematically illustrates two cell units of an exemplary fuel cell pile, where flow field plates manufactured according to a preferred example of the present application are used for these cell units;

FIG. 2 is a top view of a flow field plate according to a preferred example of the present application, schematically illustrating the first side of the flow field plate;

FIG. 3 is a bottom view of the flow field plate of FIG. 2, schematically illustrating the second side of the flow field plate opposite the first side;

FIG. 4 is a schematic cross-sectional view along line I-I of FIG. 1, schematically illustrating a cross-section of a type of flow field plate according to the present application;

FIG. 5 is a schematic cross-sectional view similar to FIG. 2, schematically illustrating a cross-section of another type of flow field plate according to the present application;

FIG. 6 schematically illustrates a top view of a laminated structure including a first conductive adhesive film disposed between two layers of backing film according to a preferred example of the present application;

FIG. 7 is a side view of the laminated structure of FIG. 6.

FIG. 8 is a top view of the laminated structure of FIG. 6, schematically illustrating a first pattern cut out in the laminated structure.

FIG. 9 is a top view similar to FIG. 2, wherein, the first conductive adhesive film and the second adhesive film have not yet adhered to the metal plate of the flow field plate;

FIG. 10 is a top view similar to FIGS. 2 and 9, wherein, the first conductive adhesive film is adhered to the metal plate of the flow field plate, while the second adhesive film has not yet adhered to the metal plate of the flow field plate;

FIG. 11 is an enlarged view of the dashed area A of FIG. 10, schematically illustrating a type of flow channel structure that can be formed by the manufacturing method according to the present application; and FIG. 12 is an enlarged view of the dashed area B of FIG. 10, schematically illustrating a type of flow channel structure that can be formed by the manufacturing method according to the present application.

### LIST OF REFERENCE NUMERALS

1 Cell Unit
3 Proton Exchange Membrane
5 Cathode Diffusion Layer
7 Cathode Catalyst Layer Structure
9 Anode Diffusion Layer
11 Anode Catalyst Layer Structure
100 Flow Field Plate
101 Metal Plate
101a First Side
101b Second Side
101c Inlet
101d Outlet
101e Inlet
101f Outlet
101g First Opening
101h Second Opening
103 First Flow Field
105 Inlet Distribution Zone
107 Reaction Zone
107a1 Side Wall
107a2 Bottom Wall
107a First Flow Channel
107b First Ridge
107b1 Top
107b2 Bottom
108 Protrusion
109 Outlet Collection Zone
111 First Conductive Adhesive Film
113a Second Flow Channel
113b Second Ridge
113b1 Top
115 Second Flow Field
117a Third Flow Channel
117b Third Ridge
117b1 Top
118 Third Conductive Adhesive Film
200 Backing Film
300 Laminated Structure

### Specific Embodiments

Some preferred examples of the present application are described in detail below in conjunction with the examples. Those skilled in the art should understand that these examples are merely exemplary and are not intended to impose any limitations on the present application. Furthermore, features in the examples of this application may be combined with each other, provided there is no conflict. In the attached drawings, other components have been omitted for brevity, but this does not imply that the flow field plate, bipolar plate, fuel cell unit, and fuel cell of this application cannot include other structures and components. It should be understood that the dimensions, proportional relationships, and the number of components shown in the drawings are not to be considered as limitations on the present application.

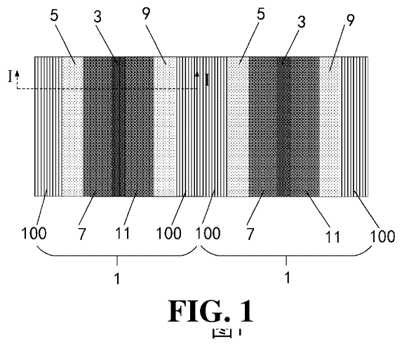

The fuel cell can be used in vehicles to provide electricity, thereby driving the vehicle's motor to supply power or enabling the onboard systems to perform various functions. FIG. 1 schematically illustrates two cell units 1 of an exemplary fuel cell pile. An exemplary fuel cell is a Proton Exchange Membrane Fuel Cell (PEMFC), and its pile is formed by piling multiple cell units 1. As will be described in detail below, a flow field plate 100 manufactured according to a preferred example of the present application can be used in the cell unit 1 to serve as a cathode plate and/or an anode plate. For instance, in one cell unit 1, a flow field plate 100 may be used as a cathode plate, and another flow field plate 100 may be used as an anode plate. Additionally, the flow field plate 100 can be combined with other flow field plates.

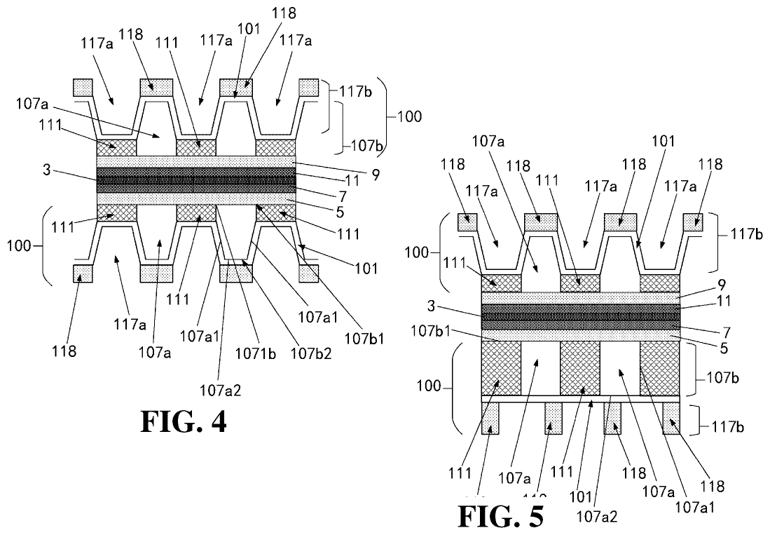

As shown in FIG. 1, each cell unit 1 typically consists of a cathode plate (the flow field plate 100 on the left side of each cell unit 1 in FIG. 1), an anode plate (the flow field plate 100 on the right side of each cell unit 1 in FIG. 1), a proton exchange membrane 3, a cathode diffusion layer 5 and a cathode catalyst layer structure 7 between the cathode plate and the proton exchange membrane 3, and an anode diffusion layer 9 and an anode catalyst layer structure 11 between the anode plate and the proton exchange membrane 3. The cathode diffusion layer 5, cathode catalyst layer structure 7, anode diffusion layer 9, anode catalyst layer structure 11, and proton exchange membrane 3 are typically integrated into a single unit, referred to as a Membrane Electrode Assembly (MEA). The cathode diffusion layer 5 and anode diffusion layer 9 are used to support the cathode catalyst layer structure 7 and anode catalyst layer structure 11, respectively, and to transport reactive fluids and reaction products (such as hydrogen, oxygen/air, water, etc.). As schematically illustrated in FIGS. 4 and 5, a cathode flow field and an anode flow field are respectively formed on the cathode plate and anode plate. The cathode flow fields of the cathode plates of multiple cell units 1 can form the cathode flow channel of the pile (not shown), and the anode flow fields of the anode plates of multiple cell units 1 can form the anode flow channel of the pile (also not shown).

The electrochemical reactions in the PEMFC occur in the MEA, primarily involving the Hydrogen Oxidation Reaction (HOR) process and the Oxygen Reduction Reaction (ORR) process. H₂ and O₂ are respectively transported through the anode diffusion layer 9 and cathode diffusion layer 5 to the anode catalyst layer structure 11 and cathode catalyst layer structure 7, where H₂ loses electrons under the action of the anode catalyst at the anode catalyst layer structure 11, forming H⁺. H⁺ is transferred through the proton exchange membrane 3 to the cathode side, where it combines with O2 under the action of the cathode catalyst at the cathode catalyst layer structure 7 to form H₂O. H₂O is transferred through the cathode diffusion layer 5 and anode diffusion layer 9 to the cathode flow field and anode flow field, and then discharged from the PEMFC through the cathode flow channel and anode flow channel. Electrons flow through an external circuit (not shown) to the cathode to form a current.

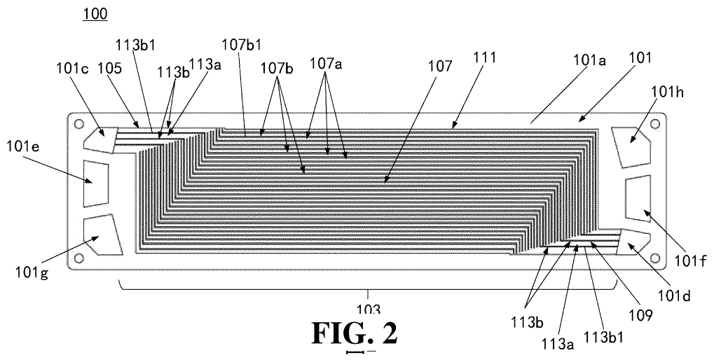

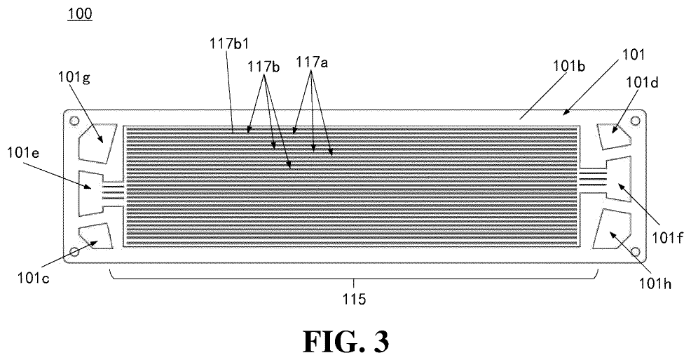

FIGS. 2 to 4 schematically illustrate a flow field plate 100 constructed through a manufacturing method according to a preferred example of the present application. As shown in FIGS. 2 and 3, the flow field plate 100 comprises a metal plate 101 having opposite first side 101a and second side 101b. The metal plate 101 can be made of iron-based alloys (stainless steel), light metals and their alloys (primarily titanium and its alloys, aluminum and its alloys). The metal plate 101 comprises an inlet 101c configured to receive reactive fluids (reactive gases in a PEMFC, specifically hydrogen, oxygen, or air), and an outlet 101d configured to discharge reaction products. The inlet 101c and outlet 101d are openings extending through the metal plate 101.

As shown in FIGS. 2 and 4, the flow field plate 100 further comprises a first flow field 103 formed on the first side 101a of the metal plate 101 for circulating reactive fluids. The first flow field 103 comprises an inlet distribution zone 105, a reaction zone 107, and an outlet collection zone 109 sequentially arranged along the flow direction of the reactive gases. The reaction zone 107 comprises a first ridge 107b defining a first flow channel 107a. The first flow channel 107a extends between the inlet distribution zone 105 and the outlet collection zone 109. The inlet distribution zone 105 of the first flow field 103 is configured to be disposed near the inlet 101c of the metal plate 101 and communicate with the inlet 101c to receive reactive gases from the inlet 101c, and is configured to distribute the reactive gases to the respective flow channels 107a. The outlet collection zone 109 is configured to collect reaction products from the first flow channel 107a and is configured to be disposed near the outlet 101d of the metal plate 101 and communicate with the outlet 101d to discharge reaction products to the outlet 101d.

Please continue referring to FIG. 2 and FIG. 4. The flow field plate 100 further comprises a first conductive adhesive film 111, which is patterned to correspond to the first ridge 107b and is adhered to first side 101a of the metal plate 101. This arrangement ensures that at least 10% (e.g., 10%, 20%, 30%, 40%, 50%, 60%, 70%, 80%, 90%, 100%, or any value in between) of the height of the first ridge 107b, measured from the top 107b1 (FIG. 4), is formed by the first pattern. 111 As best illustrated in FIG. 4, when the flow field plate 100 is used as an anode or cathode plate and assembled with the MEA, the first conductive adhesive film 111 can bond the metal plate 101 to the respective diffusion layers in the cathode diffusion layer 5 and the anode diffusion layer 9 of the MEA.

As will be specifically described in conjunction with the method for manufacturing the flow field plate 100, the inventors have realized that the aforementioned configuration of the flow field plate 100 according to the present application can provide several advantages: (1) The first conductive adhesive film 111 can maintain a stable adhesive force between the metal plate 101 and the respective diffusion layers in the cathode diffusion layer 5 and the anode diffusion layer 9 during the long-term operation of the fuel cell, keeping the contact resistance substantially constant. This helps improve the contact conductivity of the flow field plate 100, thereby enhancing the reliability and power generation performance of the fuel cell; (2) The provision of the first conductive adhesive film 111 can reduce the need for applying additional holding force between the metal plate 101 and the respective diffusion layers in the cathode diffusion layer 5 and the anode diffusion layer 9, improving the reliability of the fuel cell; (3) The first conductive adhesive film 111 covers a portion of the metal plate 101, helping to prevent corrosion on that portion of the metal plate 101, thereby extending the service life of the flow field plate 100; (4) The first conductive adhesive film 111 is fixed to the metal plate 101 by adhesion, eliminating the need for complex and time-consuming surface modification processes on the metal plate 101, making the flow field plate 100 easy to manufacture and reducing manufacturing costs, thus facilitating the mass production of the flow field plate 100; (5) At least 10% of the height of the first ridge 107b, measured from the top 107b1, is formed by the first pattern, allowing the first conductive adhesive film 111 to form at least a part of the reaction zone 107 flow field. This helps reduce or even eliminate the stamping work required in the manufacturing of the reaction zone 107 of the flow field plate 100, enhancing the flexibility in the design and manufacturing of the flow field plate 100.

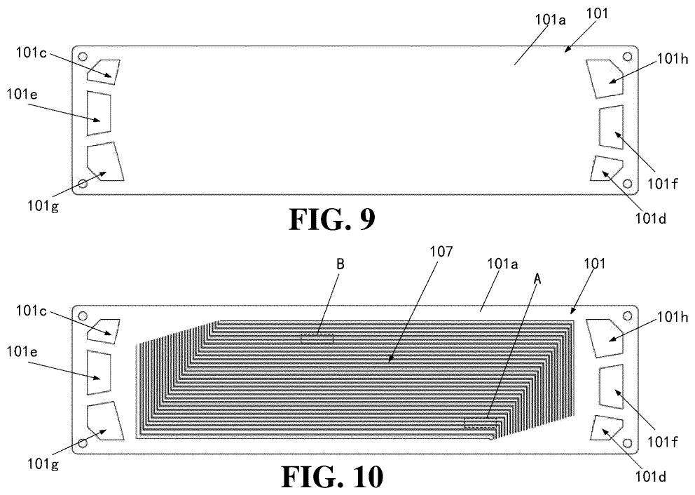

Exemplary methods for manufacturing the flow field plate 100 according to the present application will be specifically described in conjunction with FIGS. 4 to 10. FIG. 9 is a top view of the metal plate 101, schematically illustrating the first side 101a of the metal plate 101. The metal plate 101 has already been formed with an inlet 101c and an outlet 101d. The inlet 101c and outlet 101d of the metal plate 101 can be formed by any known processes in the art, such as machining, stamping, etc.

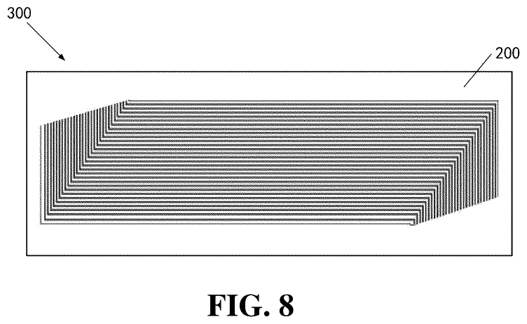

The method for manufacturing the flow field plate 100 according to the present application comprises forming a first flow field 103 for circulating reactive fluid on the first side 101a of the metal plate 101. As described above, the reaction zone 107 of the first flow field 103 comprises first ridges 107b defining the first flow channels 107a. Forming the first flow field 103 comprises the following steps: (1) Cutting a first pattern corresponding to the first ridges 107b in the first conductive adhesive film 111 (FIG. 8); and (2) Adhering the cut first pattern to the metal plate 101 on the first side 101a, so that at least 10% of the height of the first ridges 107b, measured from the top, is formed by the first pattern (FIG. 10). It is understood that the manufacturing method according to the present application can provide the aforementioned advantages (1) to (5).

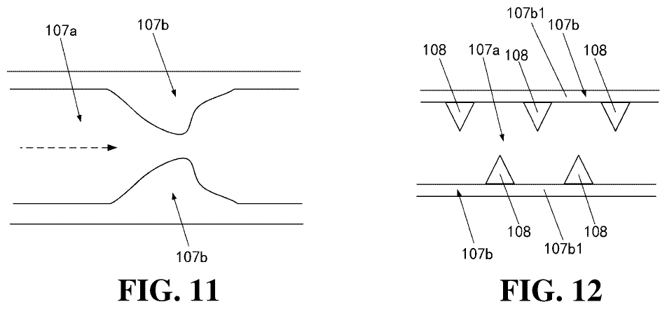

The manufacturing method according to the present application improves the flexibility in the design and manufacturing of the flow field plate 100. For example, FIGS. 11 and 12 illustrate two flow channel structures that can be formed by the manufacturing method of the present application. FIG. 11 shows a first flow channel 107a with a necking structure. The first flow channel 107a is defined by the shape of the first ridges 107b. Specifically, the flow area of the first flow channel 107a first decreases and then increases along the flow direction of the reactive fluid (as indicated by the dashed arrow in the figure), thereby accelerating the flow of the reactive fluid or reaction products. Herein, unless otherwise specified, “flow area” refers to the effective cross-sectional area of a channel for fluid flow in a component or part. This necking structure can be set at a desired location in the first flow field 103 to achieve the effect of accelerating the flow of reactive fluid or reaction products. For example, this necking structure can be set at a downstream location in the reaction zone of the cathode flow field to accelerate the discharge of reaction products. FIG. 12 shows a first flow channel 107a with a turbulence structure. Specifically, protrusions 108 can be provided on the side walls of the first flow channel 107a (i.e., the first ridges 107b) protruding into the first flow channel 107a to create turbulence in the reactive fluid. This helps enhance the reaction in the reaction zone 107.

The flow channel structures shown in FIGS. 11 and 12 are difficult to form by traditional processes such as stamping and machining. In contrast, with the aid of the manufacturing method of the present application, the first flow channel 107a with necking and turbulence structures can be easily and cost-effectively formed. It should be understood that the manufacturing method of the present application can also easily and cost-effectively form other flow channel structures that are difficult to form by traditional processes such as stamping and machining, and the present application is not limited thereto.

Furthermore, compared to traditional processes such as stamping and machining, the manufacturing method of the present application can easily and cost-effectively form various complex flow field patterns, reducing or even eliminating the cost of designing and manufacturing stamping molds.

It is important that the manufacturing method according to the present application can improve the flexibility in the design and manufacturing of the flow field plate 100.

In some examples, the entire (100%) height of the first ridge 107b, measured from the top 107b1, can be formed by the first conductive adhesive film 111 (i.e., the first pattern). As shown in FIGS. 5 and 9, the first region of the metal plate 101 corresponding to the reaction zone 107 is substantially flat. As used herein, “substantially flat” means within the allowable range of manufacturing tolerances. In this case, the first pattern can be configured such that the entire height of the first ridge 107b measured from the top 107b1 is formed by the first pattern. Accordingly, the step of adhering the cut first pattern to the first side 101a of the metal plate 101 comprises adhering the cut first pattern to the first region of the metal plate 101 on the first side 101a to form the entire first ridge 107b. This method can further improve the flexibility of designing and manufacturing the flow field plate 100. For example, referring to the structure of the flow field plate 100 (used as a cathode plate) in the lower part of FIG. 5, the entire height of the first ridge 107b, measured from the top 107b1, is formed by the first conductive adhesive film 111 (i.e., the first pattern). In this case, the sidewalls 107al of the first flow channel 107a can be perpendicular to the bottom wall 107a2 of the first flow channel 107a, i.e., the draft angle is 0. This flow channel structure helps to increase the flow channel density in the reaction zone 107, thereby improving the performance of the flow field plate 100. Such a flow channel structure is difficult to form by traditional processes such as stamping and machining. In contrast, with the manufacturing method of the present application, it is possible to easily and cost-effectively form the first flow channel 107a with sidewalls 107a1 perpendicular to the bottom wall 107a2 of the first flow channel 107a. In other partial examples, as shown in FIGS. 4 and 5, a portion of the height of the first ridge 107b measured from the bottom 107b2 opposite the top 107b1 can be formed by stamping the metal plate 101. Specifically, referring to the structure of the flow field plate 100 (used as an anode plate) in the upper part of FIG. 5, the first ridge 107b is composed of a first portion and a second portion. The first portion is formed by stamping the metal plate 101, and the second portion is formed by adhering the first conductive adhesive film 111 to the first portion. That is, forming the first flow field 103 further comprises the step of forming the first portion of the first ridge 107b by stamping the metal plate 101, and the step of adhering the cut first pattern to the first side 101a of the metal plate 101 comprises adhering the cut first pattern to the first portion to form the second portion, thereby forming the entire first ridge 107b.

The first conductive adhesive film 111 comprises a first adhesive material and first conductive particles dispersed in the first adhesive material. The first conductive particles can be dispersed in the first adhesive material by any suitable process at any suitable weight percentage. This specifically depends on the conductive properties of the first adhesive material itself and the density and conductivity of the first conductive particles. Preferably, the first adhesive material can be polymethyl methacrylate (PMMA), acrylic adhesive, polypyrrole, epoxy resin, silicone resin, polyamide, polyimide, or fluororubber. Preferably, the first conductive particles can be gold (Au), graphite, high specific surface area carbon materials such as Ketjen black, carbon black, graphene, single-walled carbon nanotubes, multi-walled carbon nanotubes, chromium nitride (CrN), or titanium nitride (TiN). It should be understood that the present application is not limited to this, and the first adhesive material and the first conductive particles can be any suitable materials that enable the first conductive adhesive film 111 to maintain stable adhesion between the metal plate 101 and the respective diffusion layers in the cathode diffusion layer 5 and the anode diffusion layer 9 and maintain a substantially constant contact resistance.

In some examples, the first conductive adhesive film 111 is configured to adhere the metal plate 101 to the respective diffusion layers in the cathode diffusion layer 5 and the anode diffusion layer 9 to provide an adhesive force of at least 2N/cm (e.g., 2N/cm, 2.5N/cm, 3N/cm, or higher) between the respective diffusion layers and the metal plate 101. This helps to maintain stable adhesion and a substantially constant contact resistance between the metal plate 101 and the respective diffusion layers. Additionally, it also helps to meet the demand for applying additional holding force between the metal plate 101 and the respective diffusion layers.

As shown in FIGS. 4 and 5, each first flow channel 107a is defined by two sidewalls 107a1 and a bottom wall 107a2 extending between the two sidewalls 107a1. The two sidewalls 107a1 are formed by two adjacent first ridges 107b, and the bottom wall 107a2 is formed by the portion of the metal plate 101 between the two adjacent first ridges 107b. The first pattern (i.e., the conductive adhesive film 111) does not overlap with portions of the metal plate 101. It should be understood that the portion of the metal plate 101 between the two adjacent first ridges 107b or the entire metal plate 101 can be surface-treated to have corrosion resistance.

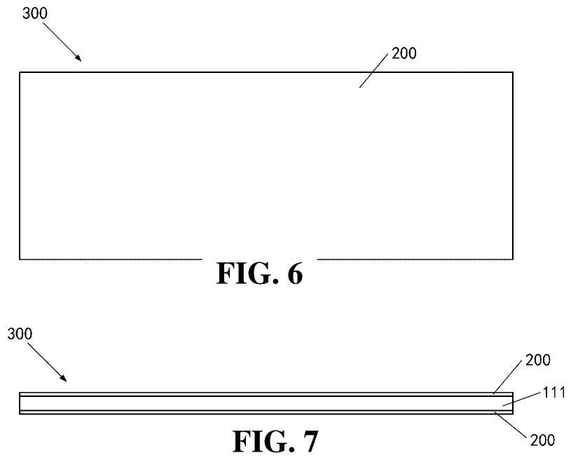

In some examples, as shown in FIGS. 6 to 8, the step of cutting out the first pattern corresponding to the first ridge 107b in the first conductive adhesive film 111 can comprise disposing the first conductive adhesive film 111 between two layers of backing film 200 to form a laminated structure 300 and cutting out the first pattern corresponding to the first ridge 107b in the laminated structure 300. FIG. 6 schematically shows a top view of the laminated structure 300 comprising the first conductive adhesive film 111 disposed between two layers of backing film 200, FIG. 7 is a side view of the laminated structure of FIG. 6, and FIG. 8 is a top view of the laminated structure 300 of FIG. 6, schematically showing the first pattern cut out in the laminated structure 300. Subsequently, the step of adhering the cut-out first pattern to the first side 101a of the metal plate 101 can comprise peeling the cut first pattern from the backing film 200 and adhering it to the first side 101a of the metal plate 101 (as shown in FIG. 10). The backing film 200 can be made from a material suitable for holding the first conductive adhesive film 111 during the cutting of the first pattern from the first conductive adhesive film 111 and easily peeling the first conductive adhesive film 111 from it without damage after the first pattern is cut.

Referring back to FIG. 2, the inlet distribution zone 105 and the outlet collection zone 109 of the first flow field 103 can be formed in a manner similar to the reaction zone 107. Specifically, at least one of the inlet distribution zone 105 and the outlet collection zone 109 comprises a second ridge 113b defining a second flow channel 113a. The flow field plate 100 further comprises a second adhesive film (not shown), which is patterned to correspond to the second ridge 113b and is adhered to the first side 101a of the metal plate 101, so that at least a portion (e.g., 10%, 20%, 30%, 40%, 50%, 60%, 70%, 80%, 90%, 100%, or any value therebetween) of the height of the second ridge 113b, measured from the top 113b1, is formed by the second pattern. In other words, forming the first flow field 103 further comprises the following steps: cutting a second pattern corresponding to the second ridge 113b in the second adhesive film; and adhering the cut second pattern to the first side 101a of the metal plate 101, so that at least a portion of the height of the second ridge 113b, measured from the top 113b1, is formed by the second pattern.

In this way, several advantages can be provided: (1) the second adhesive film can further help maintain a stable adhesive force between the metal plate 101 and the respective diffusion layers in the cathode diffusion layer 5 and the anode diffusion layer 9, thereby keeping the contact resistance substantially constant, which helps improve the contact conductivity of the flow field plate 100, thus enhancing the performance of the fuel cell using the flow field plate 100; (2) at least a portion of the height of the second ridge 113b, measured from the top 113b1, is formed by the second pattern, which allows the second adhesive film to form at least a portion of the flow field in at least one of the inlet distribution zone 105 and the outlet collection zone 109, helping to reduce or even eliminate the stamping work required in manufacturing at least one of the inlet distribution zone 105 and the outlet collection zone 109 of the flow field plate 100, and improving the design and manufacturing flexibility of the flow field plate 100.

Preferably, the second adhesive film can be a polyethylenenaphthalate (PEN), polyethylene terephthalate (PET), or polyimide (PI) film with an acrylic adhesive coated on its surface. It should be understood that the second adhesive film is not limited to this and can also be made from other suitable materials.

In some examples, as shown in FIG. 9, at least one of the second regions of the inlet distribution zone 105 and the outlet collection zone 109 of the metal plate 101 is substantially flat. It is contemplated that the second adhesive film may be adhered to the second region (FIG. 2) and configured such that the entire height of the second ridge 113b, measured from the top 113b1, is formed by the second pattern. In other words, the second pattern is configured such that the entire height of the second ridge, measured from the top 107b1, is formed by the second pattern, and the step of adhering the cut second pattern to the first side 101a of the metal plate 101 comprises adhering the cut second pattern to the second region of the metal plate 101 on the first side 101a to form the entire second ridge 113b. It should be understood that the method described herein, as described above in connection with the reaction zone 107, can easily and cost-effectively form the flow channel structures and flow channel patterns of the inlet distribution zone 105 and the outlet collection zone 109 that are difficult to form by traditional processes such as stamping and machining. It should also be understood that in other partial examples, a portion of the second ridge 113b measured from the bottom opposite the top 107b1 can be formed by stamping the metal plate 101, and the remainder of the second ridge 113b is formed by adhering the second adhesive film to that portion. Thereby, the entire second ridge 113b can be formed.

Referring back to FIGS. 2 and 3, the metal plate 101 further comprises an inlet 101e configured to receive cooling fluid and an outlet 101f configured to discharge cooling fluid. Additionally, the metal plate 101 further comprises a first opening 101g and a second opening 101h configured to communicate with the reactive fluid inlet and the reaction product outlet of another metal plate 101, respectively. The inlet 101e, outlet 101f, first opening 101g, and second opening 101h are all openings extending through the metal plate 101.

As shown in FIG. 3, the flow field plate 100 can further comprise a second flow field 115 formed on the second side 101b of the metal plate 101 opposite the first side 101a and used for circulating cooling fluid. The second flow field 115 comprises a third ridge 117b defining a third flow channel 117a. The third flow channel 117a extends between the inlet 101e and the outlet 101f. Cooling fluid flows into the second flow field 115 from the inlet 101e and exits the second flow field 115 from the outlet 101f.

It is contemplated that the second flow field 115 can be formed in a manner similar to the reaction zone 107. Specifically, the flow field plate 100 further comprises a third conductive adhesive film 118 (FIGS. 4 and 5), which is patterned to correspond to the third ridge 117b and is adhered to the second side 101b of the metal plate 101. This arrangement ensures that at least 10% (e.g., 10%, 20%, 30%, 40%, 50%, 60%, 70%, 80%, 90%, 100%, or any value in between) of the height of the first ridge 117b, measured from the top 117b1, is formed by the third pattern.

In other words, the method of the present application for forming the flow field plate 100 further comprises forming a second flow field 115 for circulating cooling fluid on the second side 101b of the metal plate 101 opposite the first side 101a. Forming the second flow field 115 comprises the following steps: cutting a third pattern corresponding to the third ridge 117b in the third conductive adhesive film 118; and adhering the cut third pattern to the second side 101b of the metal plate 101, so that at least 10% of the height of the third ridge 117b, measured from the top 117b1, is formed by the third pattern.

In this way, several advantages can be provided: (1) When two flow field plates 100 are fixed together with the first flow fields 103 facing away from each other to form a bipolar plate, the third conductive adhesive film 118 can maintain a stable adhesive force between the two flow field plates 100, thereby keeping the contact resistance substantially constant; (2) At least 10% of the height of the third ridge 117b measured from the top 117b1 is formed by the third pattern, which allows the third conductive adhesive film 118 to form at least a part of the second flow field 115 for the circulation of cooling fluid. This helps to reduce or even eliminate the stamping work required to create the second flow field 115 of the flow field plate 100 and enhances the flexibility in the design and manufacture of the flow field plate 100.

The third conductive adhesive film 118 comprises a third adhesive material and second conductive particles dispersed within the third adhesive material. The second conductive particles can be dispersed in the third adhesive material by any suitable process at any suitable weight percentage. This specifically depends on the conductive properties of the third adhesive material itself and the density and conductivity of the second conductive particles. Preferably, the third adhesive material is a phenolic resin or epoxy resin. Preferably, the second conductive particles are expanded graphite or other highly conductive carbon materials.

It is conceivable that, in some examples, the third region of the metal plate 101 corresponding to the second flow field 115 is substantially flat. The third pattern is adhered to the third region and is configured such that the entire height of the third ridge 117b, measured from the top 117b1, is formed by the third pattern. In other words, the third pattern is configured such that the entire height of the third ridge 117b, measured from the top 117b1, is formed by the third pattern, and the step of adhering the cut third pattern to the second side 101b of the metal plate 101 comprises adhering the cut third pattern to a third region of the metal plate 101 on the first side 101a to form the entire third ridge 117b. It should be understood that the method described herein, as described in connection with the reaction zone 107 above, can easily and cost-effectively form flow channel structures and flow channel patterns for the circulation of cooling fluid in the second flow field 115, which are difficult to form by traditional processes such as stamping and machining. It should also be understood that, in other partial examples, a portion of the third ridge 117b, measured from the bottom opposite the top 117b1, can be formed by stamping the metal plate 101 (e.g., while stamping the first ridge 107b), and the remaining portion of the third ridge 117b is formed by adhering the third conductive adhesive film 118 to that portion. Thereby, the entire third ridge 117b can be formed.

The flow field plate 100 manufactured according to the aforementioned method can be used as an anode plate or a cathode plate. As schematically illustrated in FIG. 1, the anode plate of one fuel cell unit 1 of two adjacent fuel cell units 1 can be fixed together with the cathode plate of another fuel cell unit 1 before assembling the pile to form a bipolar plate. In other words, the cathode plate and the anode plate manufactured by the aforementioned method can be fixed together with the first flow fields 103 facing away from each other to form a bipolar plate. In some examples, both the cathode plate and the anode plate can have a second flow field 115 for the circulation of cooling fluid, and the second flow field 115 of the cathode plate and the second flow field 115 of the anode plate can cooperate with each other to collectively form a flow field for the circulation of cooling fluid. In other partial examples, only one of the cathode plate and the anode plate has a second flow field 115 for the circulation of cooling fluid, and this second flow field 115 is used for the circulation of cooling fluid between the cathode plate and the anode plate.

In some examples, for the same bipolar plate, the entire height of the first ridge 107b of the first flow field 103 of the cathode plate is formed by the first conductive adhesive film 111, while 10% to 50% (e.g., 10%, 20%, 30%, 40%, 50%, or any value in between) of the height of the first ridge 107b of the first flow field 103 of the anode plate, measured from the top 107b1, is formed by the first conductive adhesive film 111. In this case, the remaining portion of the first ridge 107b of the first flow field 103 of the anode plate is formed by stamping. While forming the remaining portion of the first ridge 107b, at least a part of the second flow field 115 for the circulation of cooling fluid can be formed on the second side 101b opposite the first side 101a where the first flow field 103 is formed on the anode plate. The first flow field 103 of the cathode plate is used as the cathode flow field, and the first flow field 103 of the anode plate is used as the anode flow field. During the reaction, the reaction products on the cathode side comprise water, which needs to be quickly discharged from the reaction zone 107 through the cathode flow field. It is advantageous to form the entire height of the first ridge 107b of the first flow field 103 (cathode flow field) of the cathode plate by the first conductive adhesive film 111, as this allows for the formation of various flow channel structures conducive to drainage in the cathode flow field, which are difficult to form by traditional stamping.

The present disclosure reveals methods for manufacturing flow field plates for fuel cell units, methods for manufacturing bipolar plates for fuel cells, flow field plates for fuel cell units, and bipolar plates for fuel cells. Further examples and combinations thereof comprise the following:

Example 1 comprises a method for manufacturing a flow field plate for a fuel cell unit, the method comprising: forming a first flow field for circulating reactive fluid on a first side of a metal plate, with the reaction zone of the first flow field comprising a first ridge defining a first flow channel. Forming the first flow field comprises the following steps: cutting a first pattern corresponding to the first ridge in a first conductive adhesive film; and adhering the cut first pattern onto the first side of the metal plate, such that at least 10% of the height of the first ridge, measured from the top, is formed by the first pattern.

Example 2 comprises the method of Example 1, wherein: forming the first flow field further comprises the step of forming a first portion of the first ridge by stamping the metal plate, and the step of adhering the cut first pattern onto the first side of the metal plate comprises adhering the cut first pattern onto the first portion to form the entire first ridge.

Example 3 comprises the method of Example 1, wherein: a first region of the metal plate corresponding to the reaction zone is substantially flat, and the first pattern is configured such that the entire height of the first ridge, measured from the top, is formed by the first pattern, and the step of adhering the cut first pattern onto the first side of the metal plate comprises adhering the cut first pattern onto the first region of the metal plate to form the entire first ridge.

Example 4 comprises the method of Example 1, wherein, each first flow channel is defined by two side walls and a bottom wall extending between the two side walls, the two side walls are formed by two adjacent first ridges, the bottom wall is formed by a portion of the metal plate between the two adjacent first ridges, and the first pattern does not overlap with the portion of the metal plate.

Example 5 comprises the method of Example 1, wherein, the first conductive adhesive film comprises a first adhesive material and first conductive particles dispersed in the first adhesive material.

Example 6 comprises the method of Example 5, wherein: the first adhesive material is PMMA, acrylic adhesive, polypyrrole, epoxy resin, silicone resin, polyamide, polyimide, or fluororubber; and/or the first conductive particles are gold, graphite, Ketjen black, carbon black, graphene, single-walled carbon nanotubes, multi-walled carbon nanotubes, chromium nitride, or titanium nitride.

Example 7 comprises the method of Example 1, wherein, the fuel cell unit further comprises a membrane electrode assembly with a diffusion layer, and the first conductive adhesive film is configured to adhere the metal plate to the diffusion layer, providing an adhesive force of at least 2N/cm between the diffusion layer and the metal plate.

Example 8 comprises the method of Example 1, wherein: the step of cutting the first pattern corresponding to the first ridge in the first conductive adhesive film comprises disposing the first conductive adhesive film between two backing films to form a laminated structure, and cutting the first pattern corresponding to the first ridge in the laminated structure, and the step of adhering the cut first pattern onto the first side of the metal plate comprises peeling the cut first pattern from the backing film and adhering it onto the first side of the metal plate.

Example 9 comprises the method according to any one of Examples 1 to 8, wherein, the metal plate further comprises an inlet configured to receive reactive fluid and an outlet configured to discharge reaction products; the first flow field further comprises an inlet distribution zone in communication with the inlet and an outlet collection zone in communication with the outlet, with the reaction zone extending between the inlet distribution zone and the outlet collection zone, wherein, at least one of the inlet distribution zone and the outlet collection zone comprises a second ridge defining a second flow channel. Forming the first flow field further comprises the following steps: cutting a second pattern corresponding to the second ridge in a second adhesive film; and adhering the cut second pattern onto the first side of the metal plate, such that at least a portion of the height of the second ridge, measured from the top, is formed by the second pattern.

Example 10 comprises the method of Example 9, wherein: a second region of the metal plate corresponding to at least one of the inlet distribution zone and the outlet collection zone is substantially flat, and the second pattern is configured such that the entire height of the second ridge, as measured from the top, is formed by the second pattern; and the step of adhering the cut second pattern onto the first side of the metal plate comprises adhering the cut second pattern onto the second region of the metal plate to form the entire second ridge.

Example 11 comprises the method of Example 10, wherein, the second adhesive film is a PEN, PET, or PI film with a surface coated with acrylic adhesive.

Example 12 comprises the method of any one of Examples 1 to 8, wherein, the method further comprises forming a second flow field for circulating cooling fluid on a second side of the metal plate opposite the first side, the second flow field comprises a third ridge defining a second flow channel. Forming the second flow field comprises the following steps: cutting a third pattern corresponding to the third ridge in a third conductive adhesive film; and adhering the cut third pattern onto the second side of the metal plate, such that at least 10% of the height of the third ridge, measured from the top, is formed by the third pattern.

Example 13 comprises the method of Example 12, wherein: a third region of the metal plate corresponding to the second flow field is substantially flat, the third pattern is configured such that the entire height of the third ridge, as measured from the top, is formed by the third pattern; and the step of adhering the cut third pattern onto the second side of the metal plate comprises adhering the cut third pattern onto the third region of the metal plate to form the entire third ridge.

Example 14 comprises the method of Example 12, wherein, the third conductive adhesive film comprises a third adhesive material and second conductive particles dispersed in the third adhesive material, the third adhesive material is preferably phenolic resin or epoxy resin, and the second conductive particles are preferably expanded graphite.

Example 15 comprises a method for manufacturing a bipolar plate for a fuel cell, the method comprising: manufacturing a cathode plate using the method of Example 1; manufacturing an anode plate using the method of Example 1; and fixing the cathode plate and the anode plate together with the first flow field facing each other to form a bipolar plate.

Example 16 comprises the method of Example 15, wherein: the entire height of the first ridge of the first flow field of the cathode plate is formed by the first conductive adhesive film; 10% to 50% of the height of the first ridge of the first flow field of the anode plate, measured from the top, is formed by the first conductive adhesive film.

Example 17 comprises a flow field plate for a fuel cell unit, the flow field plate comprising: a metal plate; a first flow field formed on the first side of the metal plate for circulating reactive fluid, with the reaction zone of the first flow field comprising a first ridge defining a first flow channel; and a first conductive adhesive film, wherein, the first conductive adhesive film is in a first pattern corresponding to the first ridge and is adhered to the first side of the metal plate such that at least 10% of the height of the first ridge, measured from the top, is formed by the first pattern.

Example 18 comprises the flow field plate of Example 17, wherein, the first ridge is composed of a first portion and a second portion, the first portion is formed by stamping the metal plate, and the second portion is formed by adhering the first conductive adhesive film to the first portion.

Example 19 comprises the flow field plate of Example 17, wherein, the first region of the metal plate corresponding to the reaction zone is substantially flat, the first conductive adhesive film is adhered to the first region, and is configured such that the entire height of the first ridge, measured from the top, is formed by the first pattern.

Example 20 comprises the flow field plate of Example 17, wherein, each first flow channel is defined by two side walls and a bottom wall extending between the two side walls, the two side walls are formed by two adjacent first ridges, the bottom wall is formed by a portion of the metal plate between the two adjacent first ridges, and the first pattern does not overlap with the second portion of the metal plate.

Example 21 comprises the flow field plate of Example 17, wherein, the first conductive adhesive film comprises a first adhesive material and first conductive particles dispersed in the first adhesive material.

Example 22 comprises a flow field plate of Example 21, wherein, the first viscous material is PMMA, acrylic, polypyrroll, epoxy, silicone, polyamide, polyimide, or fluorine rubber, and/or the first conductive particle is gold, graphite, cochon black, carbon black, graphene, single wall carbon nanotubes, multiwall carbon nanotubes, chromium nitride, titanium nitride.

Example 23 comprises the flow field plate of Example 17, wherein, the fuel cell unit further comprises a membrane electrode assembly with a diffusion layer, and the first conductive adhesive film is configured to adhere the metal plate to the diffusion layer, providing an adhesive force of at least 2N/cm between the diffusion layer and the metal plate.

Example 24 comprises the flow field plate of Example 17, wherein, the flow field plate further comprises an inlet configured to receive reactive fluid and an outlet configured to discharge reaction products; the first flow field further comprises an inlet distribution zone in communication with the inlet and an outlet collection zone in communication with the outlet, with the reaction zone extending between the inlet distribution zone and the outlet collection zone, wherein, at least one of the inlet distribution zone and the outlet collection zone comprises a second ridge defining a second flow channel; the flow field plate further comprises a second adhesive film, the second adhesive film is in a second pattern corresponding to the second ridge, and is adhered to the first side of the metal plate such that at least a portion of the height of the second ridge, measured from the top, is formed by the second pattern.

Example 25 comprises the flow field plate of Example 24, wherein, the second adhesive film is a PEN, PET, or PI film with a surface coated with acrylic adhesive.

Example 26 comprises the flow field plate of Example 17, wherein, a second region of the metal plate corresponding to at least one of the inlet distribution zone and the outlet collection zone is substantially flat, the second adhesive film is adhered to the second region, and is configured such that the entire height of the second ridge, measured from the top, is formed by the second pattern.

Example 27 comprises the flow field plate of Example 17, wherein the flow field plate further comprises: a second flow field formed on the second side of the metal plate opposite the first side and used for circulating reactive fluid, with the reaction zone of the second flow field comprising a third ridge defining a second flow channel; and a third conductive adhesive film, wherein, the third conductive adhesive film is in a third pattern corresponding to the third ridge and is adhered to the second side of the metal plate such that at least 10% of the height of the third ridge, measured from the top, is formed by the third pattern.

Example 28 comprises the flow field plate of Example 27, wherein, the third conductive adhesive film comprises a third adhesive material and second conductive particles dispersed in the third adhesive material, the third adhesive material is preferably phenolic resin or epoxy resin, and the second conductive particles are preferably expanded graphite.

Example 29 comprises the flow field plate of example 17, wherein, a third region of the metal plate corresponding to the second flow field is substantially flat, the third pattern is adhered to the third region, and is configured such that the entire height of the third ridge, measured from the top, is formed by the third pattern.

Example 30 comprises a bipolar plate for a fuel cell, the bipolar plate comprising: an anode plate, which is the flow field plate according to Example 11; a cathode plate, which is the flow field plate according to Example 11; wherein, the anode plate and the cathode plate are fixed together with the first flow fields facing away from each other.

Example 31 comprises the bipolar plate of Example 30, wherein, the entire height of the first ridge of the first flow field of the cathode plate is formed by the first conductive adhesive film; 10% to 50% of the height of the first ridge of the first flow field of the anode plate, measured from the top, is formed by the first conductive adhesive film.

It should be understood that the terms “first,” “second,” and “third” are used solely to distinguish one component or portion from another and are not intended to limit these components and/or portions in any way.

The present application has been described in detail in conjunction with specific examples. It is evident that the above description and the examples illustrated in the accompanying drawings are to be understood as exemplary and not as limiting the present application. Those skilled in the art may make various modifications or alterations without departing from the spirit of the present application, and such modifications or alterations are not to be excluded from the scope of the present application.

1. A method for manufacturing a flow field plate for a fuel cell unit, comprising:
forming a first flow field for circulating reactive fluid on a first side of a metal plate, with the reaction zone of the first flow field comprising a first ridge defining a first flow channel,
wherein forming the first flow field comprises (i) cutting a first pattern corresponding to the first ridge in a first conductive adhesive film; and (ii) adhering the cut first pattern onto the first side of the metal plate such that at least 10% of the height of the first ridge, measured from the top, is formed by the first pattern.

2. The method according to claim 1, wherein:
(a) (i) forming the first flow field further comprises forming a first portion of the first ridge by stamping the metal plate, and (ii) adhering the cut first pattern onto the first side of the metal plate comprises adhering the cut first pattern onto the first portion of the first ridge to form the entire first ridge; or
(b) (i) a first region of the metal plate corresponding to the reaction zone is substantially flat, and the first pattern is configured such that the entire height of the first ridge, measured from the top, is formed by the first pattern, and (ii) adhering the cut first pattern onto the first side of the metal plate comprises adhering the cut first pattern onto the first region to form the entire first ridge.

3. The method according to claim 1, wherein:
the first conductive adhesive film comprises a first adhesive material and first conductive particles dispersed in the first adhesive material, wherein, the first adhesive material is PMMA, acrylic adhesive, polypyrrole, epoxy resin, silicone resin, polyamide, polyimide, or fluororubber, and the first conductive particles are gold, graphite, Ketjen black, carbon black, graphene, single-walled carbon nanotubes, multi-walled carbon nanotubes, chromium nitride, or titanium nitride; and/or
each first flow channel is defined by two side walls and a bottom wall extending between the two side walls, the two side walls being formed by two adjacent first ridges, and the bottom wall being formed by a portion of the metal plate between the two adjacent first ridges, wherein, the first pattern does not overlap with the portion of the metal plate.

4. The method according to claim 1, wherein:
the fuel cell unit further comprises a membrane electrode assembly with a diffusion layer, and the first conductive adhesive film is configured to adhere the metal plate to the diffusion layer, providing an adhesive force of at least 2N/cm between the diffusion layer and the metal plate; and/or
cutting the first pattern corresponding to the first ridge in the first conductive adhesive film comprises disposing the first conductive adhesive film between two backing films to form a laminated structure, and cutting the first pattern corresponding to the first ridge in the laminated structure, and adhering the cut first pattern onto the first side of the metal plate comprises peeling the cut first pattern from the backing film and adhering it onto the first side of the metal plate.

5. The method according claim 1, wherein:
the metal plate further comprises an inlet configured to receive reactive fluid and an outlet configured to discharge reaction products;
the first flow field further comprises an inlet distribution zone in communication with the inlet and an outlet collection zone in communication with the outlet, with the reaction zone extending between the inlet distribution zone and the outlet collection zone, wherein, at least one of the inlet distribution zone and the outlet collection zone comprises a second ridge defining a second flow channel, and forming the first flow field further comprises:
cutting a second pattern corresponding to the second ridge in a second adhesive film, wherein, the second adhesive film is a PEN, PET, or PI film with an acrylic adhesive coating; and
adhering the cut second pattern onto the first side of the metal plate such that at least a portion of the height of the second ridge, measured from the top, is formed by the second pattern.

6. The method according to claim 5, wherein:
a second region of the metal plate corresponding to at least one of the inlet distribution zone and the outlet collection zone is substantially flat, and the second pattern is configured such that the entire height of the second ridge, measured from the top, is formed by the second pattern; and
adhering the cut second pattern onto the first side of the metal plate comprises adhering the cut second pattern onto the second region of the metal plate to form the entire second ridge.

7. The method according to claim 1, wherein the method further comprises forming a second flow field for circulating cooling fluid on a second side of the metal plate opposite the first side, and the second flow field comprises a third ridge defining a second flow channel, wherein, forming the second flow field comprises:
cutting a third pattern corresponding to the third ridge in a third conductive adhesive film, with the third conductive adhesive film comprising a third adhesive material and second conductive particles dispersed in the third adhesive material, wherein, the third adhesive material is phenolic resin or epoxy resin, and the second conductive particles are expanded graphite; and
adhering the cut third pattern onto the second side of the metal plate such that at least 10% of the height of the third ridge, measured from the top, is formed by the third pattern.

8. The method according to claim 7, wherein:
a third region of the metal plate corresponding to the second flow field is substantially flat, and the third pattern is configured such that the entire height of the third ridge, measured from the top, is formed by the third pattern; and
adhering the cut third pattern onto the second side of the metal plate comprises adhering the cut third pattern onto the third region of the metal plate to form the entire third ridge.

9. A method for manufacturing a bipolar plate for a fuel cell, comprising:
manufacturing, using the method according to claim 1, a cathode plate and an anode plate; and
fixing the cathode plate and the anode plate together with the first flow fields facing each other to form a bipolar plate.

10. The method according to claim 9, wherein:
the entire height of the first ridge of the first flow field of the cathode plate is formed by the first conductive adhesive film; and
10% to 50% of the height of the first ridge of the first flow field of the anode plate, measured from the top, is formed by the first conductive adhesive film.

11. A flow field plate for a fuel cell unit, comprising:
a metal plate;
a first flow field formed on the first side of the metal plate which is configured to circulate reactive fluid, wherein, the reaction zone of the first flow field comprises a first ridge defining a first flow channel; and
a first conductive adhesive film, wherein, the first conductive adhesive film is in a first pattern corresponding to the first ridge and is adhered to the first side of the metal plate such that at least 10% of the height of the first ridge, measured from the top, is formed by the first pattern.

12. The flow field plate according to claim 11, wherein:
the first ridge includes a first portion and a second portion, the first portion being formed by stamping the metal plate, and the second portion being formed by adhering the first conductive adhesive film to the first portion; or
the first region of the metal plate corresponding to the reaction zone is substantially flat, the first conductive adhesive film is adhered to the first region, and is configured such that the entire height of the first ridge, measured from the top, is formed by the first pattern.

13. The flow field plate according to claim 11, wherein:
the first conductive adhesive film comprises a first adhesive material and first conductive particles dispersed in the first adhesive material, wherein, the first adhesive material is PMMA, acrylic adhesive, polypyrrole, epoxy resin, silicone resin, polyamide, polyimide, or fluororubber, and the first conductive particles are gold, graphite, Ketjen black, carbon black, graphene, single-walled carbon nanotubes, multi-walled carbon nanotubes, chromium nitride, or titanium nitride; and/or
each first flow channel is defined by two side walls and a bottom wall extending between the two side walls, the two side walls being formed by two adjacent first ridges, and the bottom wall being formed by a second portion of the metal plate between the two adjacent first ridges, wherein, the first pattern does not overlap with the second portion of the metal plate; and/or
the fuel cell unit further comprises a membrane electrode assembly with a diffusion layer, and the first conductive adhesive film is configured to adhere the metal plate to the diffusion layer, providing an adhesive force of at least 2N/cm between the diffusion layer and the metal plate.

14. The flow field plate according to claim 11, wherein:
the flow field plate further comprises an inlet configured to receive reactive fluid and an outlet configured to discharge reaction products;
the first flow field further comprises an inlet distribution zone in communication with the inlet and an outlet collection zone in communication with the outlet, with the reaction zone extending between the inlet distribution zone and the outlet collection zone, wherein, at least one of the inlet distribution zone and the outlet collection zone comprises a second ridge defining a second flow channel;
the flow field plate further comprises a second adhesive film, the second adhesive film is in a second pattern corresponding to the second ridge, and is adhered to the first side of the metal plate such that at least a portion of the height of the second ridge, measured from the top, is formed by the second pattern; and
the second adhesive film is a PEN, PET, or PI film with an acrylic adhesive coating.

15. The flow field plate according to claim 14, wherein:
a second region of the metal plate corresponding to at least one of the inlet distribution zone and the outlet collection zone is substantially flat, the second adhesive film is adhered to the second region, and is configured such that the entire height of the second ridge, measured from the top, is formed by the second pattern.

16. The flow field plate according to claim 11, wherein the flow field plate further comprises:
a second flow field formed on the second side of the metal plate opposite the first side and configured for circulating cooling fluid, with the second flow field comprising a third ridge defining a second flow channel; and
a third conductive adhesive film, which is in a third pattern corresponding to the third ridge, and is adhered to the second side of the metal plate such that at least 10% of the height of the third ridge, measured from the top, is formed by the third pattern, wherein, the third conductive adhesive film comprises a third adhesive material and second conductive particles dispersed in the third adhesive material, the third adhesive material is phenolic resin or epoxy resin, and the second conductive particles are expanded graphite.

17. The flow field plate according to claim 16, wherein:
a third region of the metal plate corresponding to the second flow field is substantially flat, the third pattern is adhered to the third region, and is configured such that the entire height of the third ridge, measured from the top, is formed by the third pattern.

18. A bipolar plate for a fuel cell, comprising:
an anode plate and a cathode plate, each being a flow field plate according to claim 11;
wherein the anode plate and the cathode plate are fixed together with the first flow fields facing away from each other.

19. The bipolar plate according to claim 18, wherein:
the entire height of the first ridge of the first flow field of the cathode plate is formed by the first conductive adhesive film; and
10% to 50% of the height of the first ridge of the first flow field of the anode plate, measured from the top, is formed by the first conductive adhesive film.
